(19) United States
(12) Patent Application Publication
(10) Pub. No.: US 2009/0144467 A1
(43) Pub. Date: Jun. 4, 2009

(54) INFORMATION PROCESSING DEVICE, DATA CONTROL METHOD AND RECORDING MEDIUM

(75) Inventor: Takako Suzuki, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/188,777

(22) Filed: Aug. 8, 2008

(30) Foreign Application Priority Data
Nov. 30, 2007 (JP) 2007-311066

(51) Int. Cl. G06F 13/00

(52) U.S. Cl. 710/40

(57) ABSTRACT

According to one embodiment, an information processing device includes a plurality of connection ports for connecting devices, a storage device which stores processing priority information of the plurality of connection ports, a control device which controls the devices connected to the plurality of connection ports via the plurality of connection ports, and a processing section which determines, upon occurrence of a processing request from one of the devices other than a predetermined device and the control device during data transfer between the control device and the predetermined device via one of the plurality of connection ports, a processing priority based on the processing priority information of another connection port included in the plurality of connection ports and corresponding to the occurred processing request and processes the processing request according to the determined processing priority.

### CROSS-REFERENCE TO RELATED APPLICATIONS

This application is based upon and claims the benefit of priority from Japanese Patent Application No. 2007-311066, filed Nov. 30, 2007, the entire contents of which are incorporated herein by reference.

### BACKGROUND

1. Field

One embodiment of the present invention relates to a technique of controlling external device connection ports and more particularly to an information processing device, a data control method and a recording medium capable of assigning priorities to connection ports.

2. Description of the Related Art

In general, in a device comprising a plurality of connection terminals such as a USB, the technique of avoiding concentrated load on a specific connection terminal and the technique of reserving predetermined minimal bandwidths for connection terminals have been proposed (see Jpn. Pat. Appln. KOKAI Publication No. 2001-320387).

However, according to the technique disclosed in Jpn. Pat. Appln. KOKAI Publication No. 2001-320387, minimal bandwidths for the terminals can be reserved, but priorities cannot be set for processing connection terminals.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of an overview of an information processing device according to an embodiment of the present invention.

FIG. 2 is an exemplary block diagram showing an example of a system configuration of the information processing device according to the embodiment.

FIG. 3 is an exemplary block diagram illustrating a main configuration of the information processing device according to the embodiment.

FIG. 4 shows an exemplary example of setting processing priority information used in the information processing device according to the embodiment.

FIG. 5 is an exemplary flowchart showing an example of a procedure for a data control method executed by the information processing device according to the embodiment.

FIG. 6 is an exemplary conceptual diagram showing the procedure for the data control method executed by the information processing device according to the embodiment.

FIG. 7 is an exemplary conceptual diagram showing the procedure for the data control method executed by the information processing device according to the embodiment.

### DETAILED DESCRIPTION

Various embodiments according to the invention will be described hereinafter with reference to the accompanying drawings. In general, according to one embodiment of the invention, an information processing device characterized by includes: plurality of connection ports for connecting devices; a storage device which stores processing priority information of the plurality of connection ports; a control device which controls the devices connected to the plurality of connection ports via the plurality of connection ports; and a processing section which determines, upon occurrence of a processing request from one of the devices other than a predetermined device and the control device during data transfer between the control device and the predetermined device via one of the plurality of connection ports, a processing priority based on the processing priority information of another connection port included in the plurality of connection ports and corresponding to the occurred processing request and processing the processing request according to the determined processing priority.

Hereinafter, an embodiment of the present invention will be described with reference to the accompanying drawings.

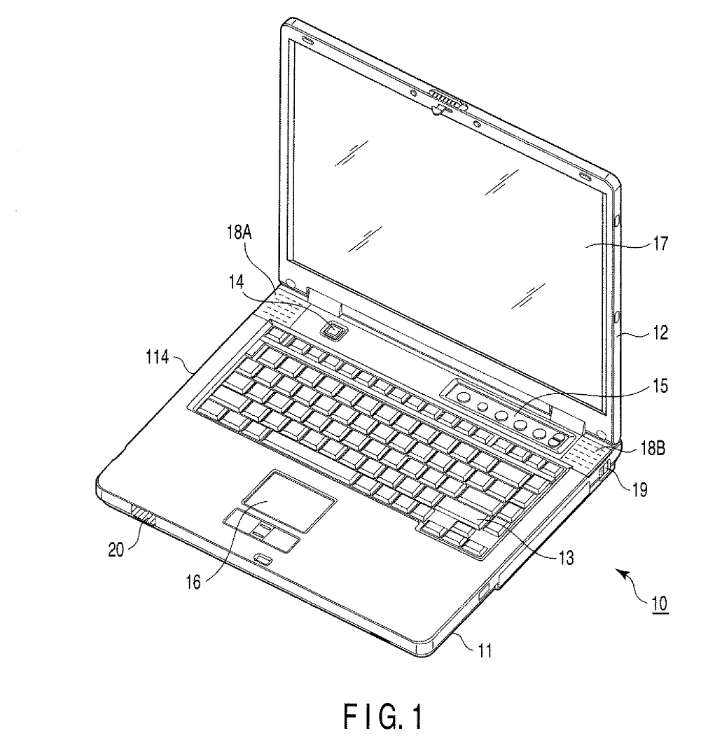

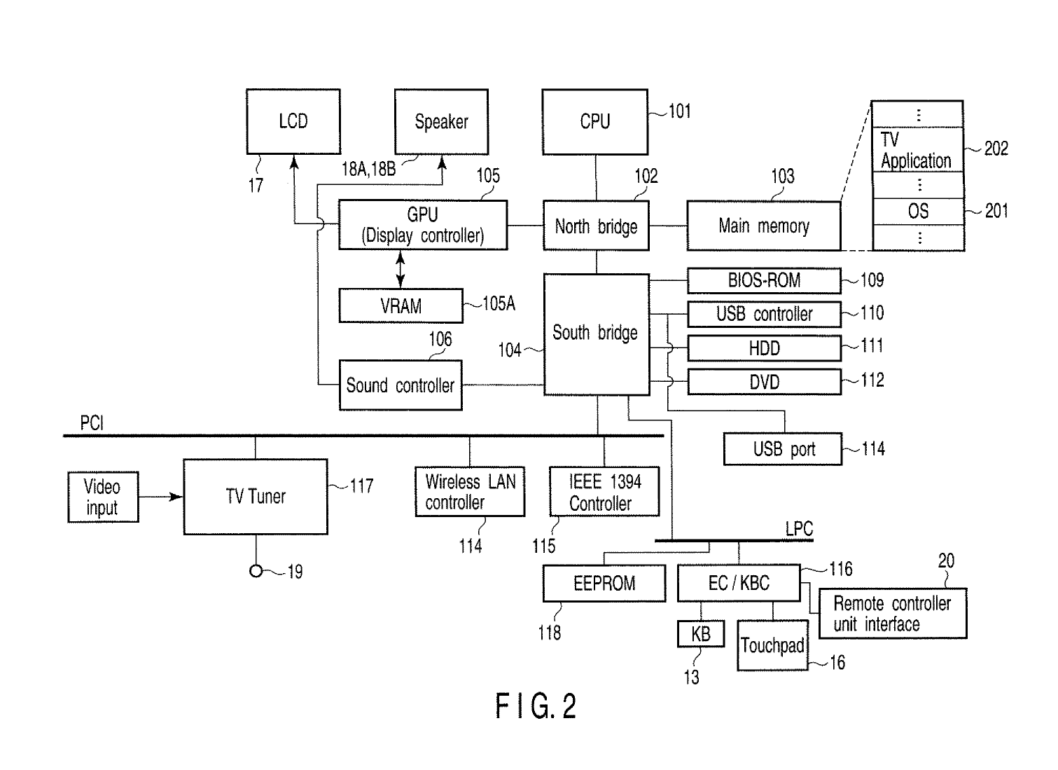

Referring to FIGS. 1 and 2, the configuration of the information processing device according to one embodiment of the present invention will be described. The information processing device according to one embodiment of the present embodiment is embodied by a notebook-sized portable personal computer 10, for example.

The personal computer 10 comprises a plurality of USB terminals, and is capable of assigning priorities to the terminals for data transfer to/from devices connected to the USB terminals.

FIG. 1 is a perspective view of the computer 10 in a state where a display unit of the computer 10 is open. The computer 10 is formed of a computer body 11 and a display unit 12. The display unit 12 includes a display device formed of a thin-film transistor liquid crystal display (TFT-LCD) 17.

The display unit 12 is rotatably mounted between an open position in which an upper surface of the computer body 11 is exposed and a closed position in which the upper surface of the computer body 11 is covered, with respect to the computer body 11. The computer body 11 has a flat box-shaped housing. On an upper surface of the housing, a keyboard 13, a power button 14 for turning on/off the computer 10, an input operation panel 15, a touch pad 16, speakers 18a, 18B, and so forth are arranged.

The input operation panel 15 is an input device which inputs an event corresponding to a pushed button, and comprises a plurality of buttons for activating a plurality of functions. On a front surface of the computer body 11, a remote controller unit interface 20 for communications with a remote controller unit which remotely controls TV functions of the computer 10. The remote controller unit interface 20 is formed of an infrared signal receiver and so forth. On the left side of the computer body 11, for example, a plurality of USB terminals 114 are provided.

Next, a system configuration of the computer 10 will be described with reference to FIG. 2.

The computer 10 comprises a CPU 101, a north bridge 102, a main memory 103, a south bridge 104, a graphics processing unit (GPU) 105, a video memory (VRAM) 105A, a sound controller 106, a BIOS-ROM 109, a USB controller 110, a hard disk drive (HDD) 111, a DVD drive 112, a plurality of USB ports (USB terminals) 114, an IEEE 1394 controller 115, an embedded controller/keyboard controller IC (EC/KBC) 116, an EEPROM 118, and so forth.

The CPU 101 is a processor for controlling operations of the computer 10. The CPU 101 executes an operating system (OS) 201 and various application programs loaded from the hard disk drive (HDD) 111 into the main memory 103. The CPU 101 also executes a Basic Input Output System (BIOS) stored in the BIOS-RON 109. The BIOS is a program for controlling hardware.

The USB controller (control device, processing section) 110 controls the USB ports (USB connection terminals) 114. The USB ports 114 are controlled according to processing priority information preset in a registry and so forth. When the USB controller 110 receives a request from a device connected to a USB port 114 assigned with a higher priority than the priority of another USB port 114 via which data is transferred to/from another device, the USB controller 110 suspends data transfer to/from another device via which data is transferred and starts data transfer to/from the device connected to the USE port 114 assigned with the higher priority, in order to process the request from the device connected to the USE port 114 assigned with the higher priority first.

The north bridge 102 is a bridge device for connecting a local bus of the CPU 101 and the south bridge 104. The north bridge 102 has a built-in memory controller for controlling access of the main memory 103. The north bridge 102 has a function of performing communications with the GPU 105 via a PCI EXPRESS standard serial bus, for example.

The GPU 105 is a display controller for controlling the LCD 17 used as a display monitor of the computer 10. A display signal generated by the GPU 105 is transmitted to the LCD 17.

The south bridge 104 controls devices on a low-pin-count (LPC) bus and devices on a Peripheral Component Interconnect (PCI) bus. Further, the south bridge 104 has a built-in Integrated Drive Electronics (IDE) controller for controlling the hard disk drive (HDD) 111 and the DVD drive 112. The south bridge 104 further has a function of performing communications with the sound controller 106.

Moreover, a video processor 113 is connected to the south bridge 104 via a PCI EXPRESS standard serial bus, for example.

The sound controller 106 is an acoustic device, and outputs audio data of an object to be played back to speakers 18A, 18B.

The wireless LAN controller 114 is a wireless communication device which performs IEEE 802.11 standard wireless communications, for example. The IEEE 1394 controller 115 performs communications with an external device via an IEEE 1394 standard serial bus.

The embedded controller/keyboard controller IC (EC/KBC) 116 is one chip micro computer in which an embedded controller for power management and a keyboard controller for controlling the keyboard (KB) 13 and the touch pad 16 are integrated. The embedded controller/keyboard controller IC (EC/KBC) 116 has a function of turning on/off the computer 10 according to an operation of a power button 14 by a user. The embedded controller/keyboard controller IC (EC/KBC) 116 further has a function of performing communications with the remote controller unit interface 20.

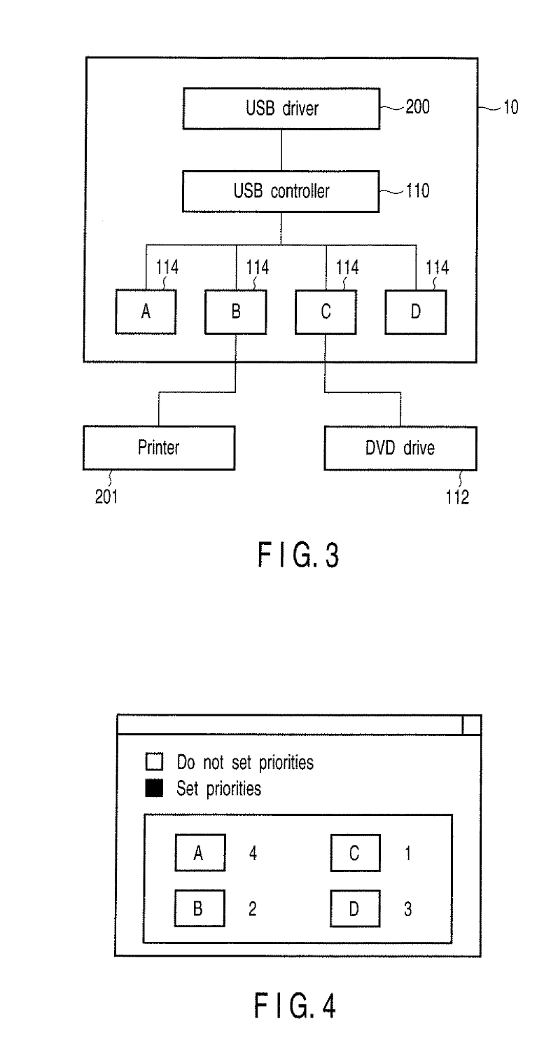

Next, a main configuration according to the embodiment will be described with reference to FIG. 3.

According to this embodiment, priorities are set for processing USB ports 114 and data transfer to/from a device with a higher priority is processed first. This control is performed by a USB driver 200 by means of the USB controller 110. In this embodiment, an example of using the USB ports 114 as connection terminals will be explained. The present embodiment is not limited thereto and is applicable to a case where a plurality of connection terminals capable of connecting external devices are provided.

First, assume that the computer 10 comprises four USB ports 114, ports A-D, for example. To ports A-D, USB connection devices such as a printer 201 and a DVD drive 112 are connected.

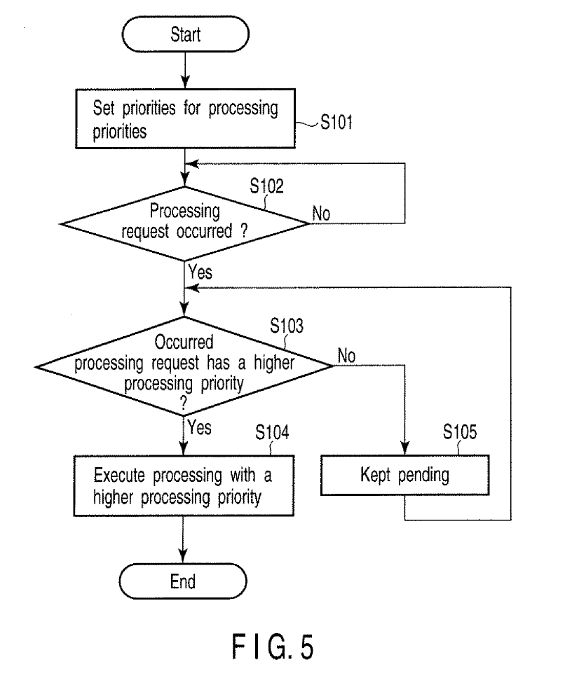

With the aforementioned configuration, a data control method using the information processing device according to the present embodiment will be described below with reference to the flowchart shown in FIG. 5.

Processing priorities are assigned to ports A-D and stored in a registry, for example, as processing priority information (Block S101), as shown in FIG. 4. When “Set Priorities” is checked in FIG. 4, the order in which ports A-D are processed can be input in Arabic numerals, for example. Assume that port A is given processing priority 4, port B is given processing priority 2, port C is given processing priority 1, and port D is given processing priority 3, for example.

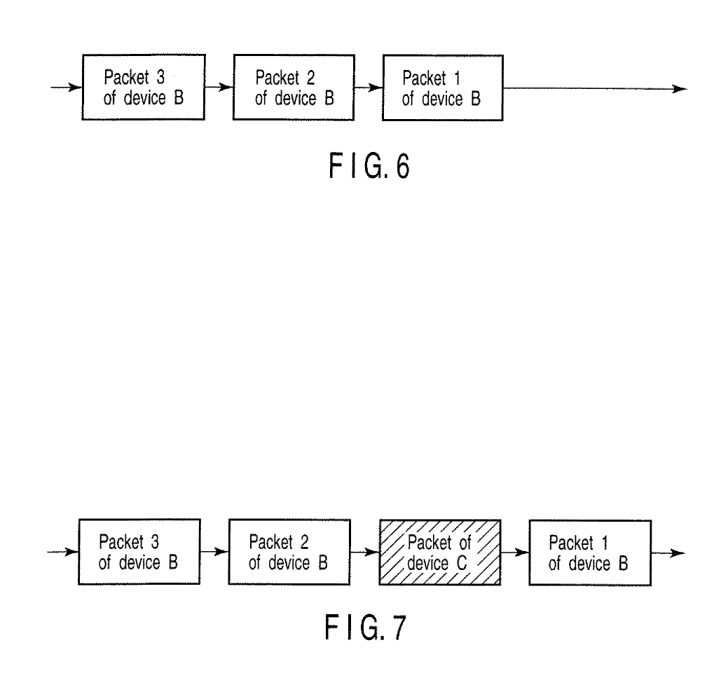

When a processing request occurs from a device connected to a port (YES in Block S102), for example, when a movie replay processing request is received from the DVD drive 112 connected to port C, during data transfer to/from a printer 201 connected to port B (processing priority 2) (see FIG. 6), the USB driver 200 determines whether the occurred processing request is given a higher processing priority (Block S103).

When the USB driver 200 determines that the occurred processing request is given a higher processing priority (YES in Block S103), that is, when the movie replay processing request from the DVD drive 112 connected to port C (processing priority 1) is given a higher processing priority than the printer 201 connected to port B (processing priority 2), for example, processing with a higher processing priority is executed (Block S104). That is, the data transfer to from the printer 201 connected to port B (processing priority 2) is suspended, and processing of the movie replay processing request from the DVD drive 112 connected to port C (processing priority 1) is started (see FIG. 7). In this case, the processing of “packet data of device B”, which is data of the printer 201 connected to port B, is suspended and “packet data of device C”, which is data of the DVD drive 112 connected to port C, is interrupted and processed, as shown in FIG. 7. After processing the processing request with a higher processing priority, the suspended processing will be performed

Further, as described above, when the number of ports (such as ports B and C) to which devices are connected is smaller than the number of connection ports (such as ports A-D) of which processing priority information is stored, the USB driver (control device) 200 processes a processing request according to the processing priority information (such as processing priority 4 assigned to port A, processing priority 2 assigned to port B, processing priority 1 assigned to port C, and processing priority 3 assigned to port D) corresponding to the ports to which the devices are connected.

On the other hand, when the USB driver 200 determines that the occurred processing request is given a lower processing priority (NO in Block S103), processing of the device connected to the port with the lower processing priority is kept pending (Block S105).

When a further USB port 114 is additionally installed, that is, when port D is divided into two ports by means of a USB hub, for example, the additionally installed port, referred to as port E, is given the lowest processing priority. Accordingly, after installation of port E, port A is given processing priority 4, port B is given processing priority 2, port C is given processing priority 1, port D is given processing priority 3, and port E is given processing priority 5. Further, when the number of the USB ports 114 is decreased and thereby any processing priority is made vacant, the processing priorities will be automatically assigned again in increasing order.

It is therefore an object of the present invention to provide an information processing device, a data control method, and a recording medium capable of setting priorities for processing connection terminals.

According to the above-mentioned embodiment, priorities for processing USB connection terminals can be set, and thereby a user can assign a high priority to any USB port.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a plurality of connection ports for connecting devices;
a storage device which stores processing priority information of the plurality of connection ports;
a control device which controls the devices connected to the plurality of connection ports via the plurality of connection ports; and
a processing section which determines, upon occurrence of a processing request from one of the devices other than a predetermined device and the control device during data transfer between the control device and the predetermined device via one of the plurality of connection ports, a processing priority based on the processing priority information of another connection port included in the plurality of connection ports and corresponding to the occurred processing request and processing the processing request according to the determined processing priority

2. The information processing device according to claim 1, wherein the control device suspends data transfer between the control device and the predetermined device and processes the occurred processing request when a processing priority of said another connection port corresponding to the occurred processing request is higher than a processing priority of said one connection port via which data is transferred between the control device and the predetermined device.

3. The information processing device according to claim 1, wherein when the number of ports which are included in the plurality of connection ports and to which the devices are connected is smaller than the number of connection ports of which the processing priority information is stored, the control device processes the processing request according to the processing priority information corresponding to one of the connection ports to which the devices are connected.

4. The information processing device according to claim 1, wherein when data transfer between the control device and the predetermined device is suspended, the suspended processing is performed after processing the occurred processing request.

5. A data control method used in an information processing device comprising a plurality of connection ports for connecting devices, a storage device which stores processing priority information of each of the connection ports, and a control device which controls the devices connected to the plurality of connection ports via the plurality of connection ports,
wherein, upon occurrence of a processing request from one of the devices other than a predetermined device and the control device during data transfer between the control device and the predetermined device via one of the plurality of connection ports, the control device determines a processing priority based on the processing priority information of another connection port included in the plurality of connection ports and processes the processing request according to the determined processing priority.

6. The data control method according to claim 5, wherein when a processing priority of said another connection port corresponding to the occurred processing request is higher than a processing priority of said one connection port via which data is transferred between the control device and the predetermined device, the control device suspends data transfer between the control device and the predetermined device and processes the occurred processing request.

7. The data control method according to claim 5, wherein when the number of ports to which the devices are connected is smaller than the number of connection ports of which processing priority information is stored, the control device processes the processing request according to the processing priority information corresponding to each of the connection ports to which the devices are connected.

8. The data control method according to claim 5, wherein when data transfer between the control device and the predetermined device is suspended, the suspended processing is performed after processing of the occurred processing request.

9. A storage medium which stores programs used in an information processing device comprising a plurality of connection ports to which devices are connected, a storage device which stores processing priority information of each of the plurality of connection ports, and a control device which controls the devices connected to the plurality of connection ports via the connection ports,
wherein the programs cause a computer to execute, upon occurrence of a processing request from one of the devices other than a predetermined device and the control device during data transfer between the control device and the predetermined device via one of the connection ports, a determination procedure for determining a processing priority based on the processing priority information of one of the connection ports corresponding to the occurred processing request, and a processing procedure for processing the processing request by the control device according to the determined processing priority.

10. The storage medium according to claim 9, wherein the control device suspends data transfer between the control device and the predetermined device and processes the occurred processing request when a processing priority of the connection port via which data is transferred between the control device and the predetermined device is higher than a processing priority of the connection port corresponding to the occurred processing request.
